(19) United States
(12) Patent Application Publication
(10) Pub. No.: US 2005/0100873 A1
(43) Pub. Date: May 12, 2005

(54) System for simulating cerebrospinal injury

(76) Inventors: Jay M. Meythaler, Grosse Pointe Farms, MI (US); Jean D. Peduzzi-Nelson, Chelsea, AL (US)

Correspondence Address: GIFFORD, KRASS, GROH, SPRINKLE & CITKOWSKI, P.C, PO BOX 7021, TROY, MI, 48007-7021, US

(21) Appl. No.: 10/837,277

(22) Filed: Apr. 30, 2004

Related U.S. Application Data
(60) Provisional application No. 60/446,787, filed on May 2, 2003.

(51) Int. Cl. G09B 23/28

(52) U.S. Cl. 434/267

(57) ABSTRACT

A system for simulating cerebrospinal injury includes a simulated human head having an anatomically representative volume filled with a brain or spinal cord simulative mass material. A force sensor is located within the volume at a preselected location to yield information needed to simulate axonic cerebrospinal injury. Simulated cerebrospinal injury information is helpful in designing countermeasures to lessen such injury.

### RELATED APPLICATION

This application claims priority of U.S. Provisional Patent Application Ser. No. 60/446,787 filed May 2, 2003, which is incorporated herein by reference.

### FIELD OF THE INVENTION

The subject invention relates to an apparatus and process for simulating human central nervous system injuries and, more particularly, the subject invention relates to an apparatus and method for simulation of human traumatic brain injury and spinal cord injury and for obtaining protective data therefrom.

### BACKGROUND OF THE INVENTION

The predominant mechanism in most cases of traumatic brain injury (TBI) is diffuse axonal injury (Whyte and Rosenthal, 1993). While axonal injury is common in all TBI regardless of severity (Povlishock et al., 1992; Mittl, 1994), a shearing of the axons occurs in human diffuse axonal injury (DAI) leading to progressive changes that ultimately may result in the loss of connections between nerve cells. The slow progression of events in DAI continues for up to several weeks after injury creating a window of opportunity for therapeutic intervention. Up to now, there are no consistently reproducible small animal models for DAI which closely mimic the changes associated with DAI in humans (Maxwell et al., 1997; Povlishock, 1993). Without such a model to study the mechanism of injury, it is difficult to develop prevention and/or interventional methodologies to limit the extent of injury. In part, this may explain the lack of efficacy of the clinical trials to assess various medications to limit injury in TBI.

There are approximately 500,000 new cases of TBI in the U.S. each year (Frankowski, 1985), and the incidence requiring hospitalization is estimated to be approximately 200-225/100,000 population (Frankowski, 1986; Carus, 1993). Currently, it is estimated that brain injuries account for 12% of all hospital admissions in the United States (Sandel, 1993). When compared to spinal cord injury, which accounts for less than 1% of hospital admissions, it is clear that TBI is a medical care problem which has a significant impact financially within the United States. Approximately 30,000-44,000 people will survive a severe TBI with GCS score <9 (Glasgow Coma Score Scale, Jennett, 1981) in the U.S. each year and more than 70,000 will be significantly disabled from moderate to severe TBI (GCS≦10) (Whyte & Rosenthal, 1988). Yet with new medical management techniques, less than 10% will remain in a persistent vegetative state (Whyte, 1993; Rosner, 1992; Rosner, 1990). A GCS score of eight or less generally reflects a state of unconsciousness in which the patient demonstrates no eye opening, does not follow simple commands to move muscles, and has vocalizations which are limited to sounds. Such signs are indicative of severe brain injury (Whyte, 1993; Jennett, 1975; Jennett, 1981).

Approximately 52,000 to 56,000 people die each year from TBI (Kraus et al., 1996), resulting in direct costs approximated at more than $50 billion annually (Max et al., 1991). The costs of severe TBI to the individual and family are extremely high (McMordie, 1988). Acute medical and rehabilitation bills are often around $100,000 with some considerably higher (McMordie, 1988). The Model Systems Database for Traumatic Brain Injury demonstrates there is a correlation between the average Disability Rating Score and the combined acute care and rehabilitation charges (Bullock et al., 1995). Those with a severe TBI (GCS score of 6-8) have average combined charges of $110,842, and those with a very severe TBI (GCS score 3-5) have average combined charges of $154,256 (Lehmkuhl, 1993). About one-half of all TBIs are transportation related (Whyte, 1993; Lehmkuhl, 1993) and these patients have some of the highest combined charges for acute care and rehabilitations (Lehmkuhl, 1993). This may be related to the mechanism of TBI in high speed motor vehicle crashes, specifically the presence of diffuse axonal injury (DAI) being most prevalent in the midbrain and brain stem areas (Whyte, 1993). Clearly, brain injuries of this severity that occur with high speed acceleration-deceleration injuries have the highest costs to society. TBI clearly causes more mortality, morbidity and probably more economic loss than HIV infection in the United States.

Motor vehicle crashes of all types are responsible for approximately 40%-50% of the TBI admissions recorded in the Model TBI Systems Database (Lehmkuhl, 1993). The predominant mechanism of injury is considered to be diffuse axonal injury (DAI). Approximately 30%-40% of the fatal head injuries involve diffuse axonal injury by pathological examination (Bennett et al., 1995; McLellan, 1990). However, based on beta-amyloid precursor protein immunostaining, axonal injury may be present in all cases of fatal head injury (Gentleman et al., 1995). In cases of persistent vegetative states, Kampfl et al. (1998) recently found that all cases had evidence of DAI in magnetic resonance imaging (MRI). Diffuse axonal injury occurs even in the absence of a blow to the head and is more prevalent than previously realized. Even in mild head injury, diffuse axonal injury is present in almost one-third of the cases (Mittl et al., 1994). The defining characteristic of DAI is the morphologic change to the axons which occurs over the course of several days to weeks and the fact that multiple regions of the brain are injured. While a component of DAI is present in blunt or penetrating trauma injury, it is at the periphery of the injury zone and is much less significant than the predominant mechanism of injury. DAI is the major mechanism of injury in high speed acceleration-deceleration injuries associated with motor vehicle crashes. While all four mechanisms of TBI (DAI, blunt trauma, penetrating trauma, axonia) may be involved in such an injury, it is the predominant mechanism of injury under this condition.

Diffuse axonal injury is only one of the cellular mechanisms of traumatic brain injury. The others include such things as direct contusion to the cells, intracerebral hemorrhage (blood across the blood brain barrier), perfusion-reperfusion injury, and anoxia. In a high velocity TBI such as those sustained in a car accident and the subsequent sequelae one can have several mechanisms of cellular injury. Each of these mechanisms appears to cause a unique area and type of TBI. This also indicates that each type of cellular injury activates different cellular pathways and cellular channels. For instance, the sequelae of brain injury from a subtype of intracerebral hemorrhage described as subarachnoid hemorrhage (both spontaneous and traumatic) appears to respond to L-type Ca channel blockers but these same substances have not been protective in another type of TBI (European Study Group on Nimodipine in Severe Head Injury, “A Multicenter Trial of the Efficacy of Nimodipine on Outcome after Severe Head Injury”, J. Neurosurg., 1994, 80:797-804; Allen G S, Ahn, H S, Preziosi, T J, et al., “Cerebral Arterial Spasm—a Controlled Trial of Nimodipine in Patients with Subarachnoid Hemorrhage”, N. Eng. J. Med., 1983, 308:619-624). It is clear that other types of channels, including Ca channels, may be involved in other types of cellular injury.

In DAI, when enough force is applied to the cytoplasm of the neuronal cell, the elastic memory of the substance is exceeded. Then the amount of cytoplasmic deformation is directly related to the time the force is applied. This in turn relates to the amount of cytoskeletal disruption that occurs. The applicants' prior work has shown the severity of neuronal injury that occurs when a rat is injured at a defined Hertz is related to the length of time the force is applied. Furthermore, many of the same areas of the brain have cellular disruption (corpus callosum, mesencephalon and brain stem) as is noted in humans who have suffered high velocity TBI as is noted in motor vehicle crashes. It is understood that many who have suffered a TBI in a cause similar to a motor vehicle crash may have more than one mechanism of neural cell injury. The injury inducing methods enabled by this machine will allow applicants to analyze the causes and the subsequent effects of DAI on neuronal cells and allow testing of unique compounds to protect against further neural cell death and injury without any of the other confounding, and many times masking, causes of neural cell injury being involved. In the model described the cellular disruption was not accompanied by intracerebral hemorrhage or contusion, and does not involve primarily perfusion-reperfusion or anoxic injury to the neuronal cells. By limiting the type of injury to a single type, the present invention affords the opportunity to study the mechanism of injury, its biochemical interactions and unique compounds to protect against neural cell injury.

Many of the areas that are injured in DAI are contiguous to the areas of cerebrospinal fluid (CSF) circulation in the brain. They are thus readily accessible to treatment via diffusion with substances delivered into the CSF for circulation and such diffusion into the injured areas.

For human head injuries resulting from car collisions, the average velocity for the onset of severe injuries is 6.7 m/s (or 24.1 km/hour) as mentioned by Lorenzo et al. (1996). Most studies have been directed to the analysis of impact to the head. The Head Injury Criterion (HIC) is one method that is commonly used to assess the severity of an impact (Chou and Nyquist, 1974). Although it is considered to be the best available head injury indicator, a new finite element model using a dummy head has taken into account the effects of rotational and translational acceleration (Ueno and Melvin, 1995). Using this model, the dominant effect of translational acceleration was on principal stresses and rotational acceleration was on shear stresses.

Based on studies of head injury in primates (including man), some of the mechanical forces which bring about DAI (McLellan, 1990) have been elucidated. The crucial factors are (1) the type of acceleration/deceleration (angular rather than translational), (2) the duration of acceleration/deceleration (long rather than short), and (3) the direction of head movement (coronal rather than sagittal). Clearly angular acceleration or the associated sudden deceleration associated with an “impact” will create forces above the threshold level (McLean and Anderson, 1997). Indeed most, but not all, shaken baby syndromes are characterized by a sudden deceleration (Duhaime et al., 1998).

Current research appears to point of plastic deformation within and of the axons that leads to the predominant cause of injury. The elastic tissues of the brain have plastic properties. Once the level of force is applied to a plastic substance, it is the time period over which it is applied that causes the amount of deformation. If the elastic memory of the substance is exceeded, then there will be shearing and tearing. The high speed motor vehicle accident with deceleration lasting more than one to three seconds or several seconds of repetitive shaking can produce enough force for this to happen.

Materials research indicates that there is an amount of force which must be delivered below which plastic deformation of substances does not occur. In fact, the Gadd severity index initially attempted to measure the severity of injury utilizing an acceleration/time curve (Gadd, 1998). This critical amount of force appears to be essential in the development of injury (McLean & Anderson, 1997). This is very different from the contusive model of TBI where the forces are applied over milliseconds.

In nonhuman primates, this type of DAI has been induced utilizing a non-impact rotational device (Marguiles et al., 1990; Kobayashi et al., 1989). However, nonhuman primates are expensive models with significant limitations that do not lend themselves to extensive preclinical pharmaceutical and interventional trials. In rats, some DAI is found around the area of contusive injury (Meaney, 1994) but this is likely due to a small amount of localized shear forces. The sites of injury in a contusive model in rats do not conform to the areas of the brain associated with human injuries: the brain stem, corpus callosum and midbrain (Blumbergs, 1994).

More evidence is available on the mechanism of injury from the so-called “shaken baby syndrome” (Nelson et al., 1993). This mechanism of injury induces a DAI due to shaking the infant in a repeated coronal plant with or without rotational forces and there are often associated injuries to the optic nerve with this type of injury (Nelson et al., 1993). In animals, repeated coronal shaking of the head has been reported to produce some DAI utilizing miniature pigs (Ross et al., 1994; Kimura et al., 1996; Smith et al., 1997). In addition, similar histopathologic findings to the optic nerve injuries associated with the “shaken baby syndrome” have been noted after direct stretching of the optic nerves of guinea pigs (Maxwell et al., 1997).

This indicates that once the amount of force has reached a threshold, it is the length of time the force is applied with the associated plastic deformation that is the predominant factor which causes the intracellular damage to the organelles within the axon. Hence, there is a continuum over which DAI occurs in TBI. After the threshold of necessary force to create plastic deformation is reached, it may be the length of time over which it is applied that determines the amount of DAI. This would explain the findings of Foda et al. (1994) where some DAI was noted in areas adjacent to a contusion injury in rats. Unfortunately, most TBI occurs over several seconds (high speed transportation crashes) where DAI is likely to be the predominant method of injury. This is supported by the fact that many severe TBI patients have minimal changes noted on CT scan following motor vehicle crashes.

Motor vehicle crashes are the predominant cause of DAI. A component of DAI is felt to be present in all motor vehicle crashes where the patient has lost consciousness (Whyte, 1988). For many years, DAI has been known to be associated with a coma of immediate onset after brain injury, but the diagnosis could only be established by autopsy. Indeed, the clinical syndrome of coma without any preceding lucid interval, decerebration, and autonomic dysfunction were often ascribed to primary brainstem injury. However, it is now clear that primary brainstem lesions do not occur in isolation but rather in association with DAI and usually involve the cerebral hemispheres and cerebellum in addition to the brainstem (McLellan, 1990). Evidence of the mechanism of injury can be elicited by pathological studies of patients killed from high speed transportation injuries (Pounder, 1997) as well as pathological studies of “shaken baby syndrome,” a distinct subset of DAI (Nelson et al. 1993). A recent case report (Pounder, 1997) indicates that this shaking mechanism of DAI injury also applies to adults. The injury is characterized by specific neuropathological findings. On CT and MRI, this usually involves hemorrhagic punctate lesion of the corpus callosum, pontine-mesencephalic junction adjacent to the superior cerebellar peduncles and diffuse axonal damage in the white matter of the brain, brainstem and cerebellum which begin to atrophy within two weeks after injury (Whyte, 1988; Blumbergs, 1994).

Diffuse axonal injury in humans is characterized by widespread damage to axons in the cerebral hemispheres, the cerebellum and the brain stem and is a consistent feature of TBI (Adams, 1977; Adams, 1989; McLellan, 1990). The histological features of DAI depend on the length of time after injury, but within a day or so after injury there is evidence of damage to axons in the form of axonal bulbs. The initial findings are usually characterized microscopically utilizing neurofibrillar stains and stains for microglia which are abundant in the degenerating white matter. These findings are produced by the shear or flow of cytoplasm from the proximal end of a severed axon. Subsequently, the microscopic features correspond to Wallerian-type axonal degeneration as the axon disintegrates, which is probably due to metabolic disruption from injury and damage to the internal organelles from the lack of membrane integrity. In the first two years there is active myelin degeneration and in patients surviving longer, demyelination is the final stage of the process (McLellan, 1990). The result of the traumatic injury to the axons leads to the disconnection with various target sites, which is assumed to translate into the morbidity seen (Gennarelli, 1982; Povlishock, 1992). The severity of injury based on the histopathological changes has been graded in humans but not in experimental animals (Adams, 1977; Adam, 1989). The Adams classification (Adams, 1977; Adams, 1989) is used in human autopsy material, to classify the degree of DAI as mild, moderate or severe. In this classification, mild (grade 1) is characterized by microscopic changes in the white matter of the cerebral cortex, corpus callosum, and brain stem and occasionally in the cerebellum. Moderate (grade 2) is defined based on focal lesions in the corpus callosum. In severe (grade 3), there are additional focal lesions in the dorsolateral quadrants of the rostral brain stem (commonly in the superior cerebellar peduncle). This scheme has not been used for non-primate models because different regions of the brain are injured in the present models. However, it may be possible to apply this scheme to an appropriate model of DAI in small animals that is currently under development.

It has been difficult to correlate the severity of injury in humans with animal models. Animals cannot be accurately assessed by the Glasgow Coma Scale (Jennet, 1981), the Disability Rating Scale (Rappaport, 1982) or the length of post traumatic amnesia (Bishara, 1992). However, there are methods to measure the balance of animals and test their spatial memory and learning acquisition. Although non-human primates most closely resemble humans, monkeys are expensive to study. Most preclinical pharmacological studies involve rats because they are easily studied and relatively inexpensive so that large scale testing can be done. Yet, there has been no reliable reproducible rat model for DAI in the literature. There are problems; clearly the anatomy and geometry of the rat brain are less similar to the human brain than a monkey. However, by using engineering to replicate the mechanical aspects of diffuse axonal injury, the changes that occur in the rat brain are projected to be quite similar to the human condition.

The two most common animal models of human head injury are the fluid percussion and impact acceleration or weight-drop method. Fluid percussion models produce brain injury by rapidly injecting saline or blood into the closed cranium either at the midline (McIntosh et al. 1984) or laterally (McIntosh et al., 1989a). Unfortunately, these are not ideal models of human diffuse axonal injury. The models more closely replicate some of the features of subarachnoid hemorrhage. The impact acceleration (Lighthall, 1988) and the weight-drop methods (Shohami et al., 1994) both involve creating an indentation into the brain. Although some diffuse axonal injury occurs with these models, DAI is present in different areas and involve a disproportionately small volume than in humans. In order to develop a better animal model that includes diffuse axonal injury in the forebrain as is characteristic of human diffuse axonal injury, Meaney and colleagues in 1994 modified the impact-acceleration model. This new cortical impact model involves creating an indentation (1.5 mm indentation, 4.7 m/sec velocity, 22 msec dwell time) on the motor cortex combined with a contralateral craniotomy. Unfortunately, this model still lacks many features of human diffuse axonal injury. Yet another model of DAI in rats, involves dropping a weight onto a metallic disc fixed to the skull (Foda and Marrnarou, 1994). Although some features of human diffuse axonal injury are seen, there are considerable amounts of brain edema and neuronal injury directly under the area of impact. This model was designed to create enough energy to reach the threshold for which some DAI will develop (McLean and Anderson, 1997). However, in models where DAI is found secondary to a contusive injury, studies directed at evaluating a treatment for DAI will be severely hindered.

In animals, repeated coronal shaking of the head has been reported to produce some DAI utilizing miniature pigs (Ross et al., 1994; Kimura et al., 1996; Smith et al., 1997). In addition, similar histopathologic findings to the optic nerve injuries associated with the “shaken baby syndrome” have been noted after direct stretching of the optic nerves of guinea pigs (Maxwell et al., 1997). In nonhuman primates, this type of DAI has been induced utilizing a non-impact rotational device (Marguiles et al. 1990; Kobayashi et al., 1989). However, nonhuman primates are expensive models with significant limitations that do not lend themselves to extensive preclinical pharmaceutical and device interventional trials.

Maxwell, Povlishock and Graham (1997) states that with the current animal models of diffuse axonal injury, axonal injury does not occur in the parasagittal white matter or corpus callosum which are the most frequent sites of axonal injury in human diffuse axonal injury. They go on to suggest that the term “diffuse axonal injury” mot be used in animal models because the animal models differ from human diffuse axonal injury. The most similar model to human DAI was a primate model of DAI in which monkeys were exposed to acceleration and deceleration in the oblique, lateral and sagittal planes (Gennarelli, 1982). While the injury induced was similar to humans, primate models are prohibitively expensive when considering preclinical therapeutic interventions.

All of the clinical trials evaluating treatments for traumatic brain injury have failed. The reason for this failure may be the lack of an adequate injury model in small experimental animals such as rats and mice. An injury model that closely mimics human injury is essential in developing and evaluating treatments for patients with head injury. A device has been developed for producing a small animal model for the most common type of traumatic head injury called diffuse axonal injury (DAI) as detailed in U.S. Pat. No. 6,588,431.

By extension, there exists a need for an accurate model which closely approximates the forces involved in causing human TBI and spinal cord injury which overcomes the drawbacks and disadvantages of the models described above.

### SUMMARY OF THE INVENTION

A system for simulating cerebrospinal injury includes a simulated human head having an anatomically representative volume filled with a brain or spinal cord simulative mass material. A force sensor is located within the volume at a preselected location to yield information needed to simulate axonic cerebrospinal injury. Simulated cerebrospinal injury information is helpful in designing countermeasures to lessen such injury.

A process for simulating cerebrospinal injury is detailed that includes the step of forming a simulative human head and locating a force sensor therein. Subjecting the simulative human head to an external force yields measurements of the forces experienced by the force sensor. Communicating those forces to a computational processing unit facilitates calculations of axonic injury in an actual human head under the same external forces.

A system embodiment includes a simulated human head having at least one force sensor in mechanical force transmitting communication therewith. The force sensor generates an electrical output in response to a force applied thereto. The force sensor is disposed at a preselected location in a material mass within 30% of the density of the brain and/or spinal cord tissue. Preferably the simulative material mass is simultaneously within 50% of the viscosity of the simulated tissue. A computation device is disposed in electrical communication with the at least one force sensor and receives the electrical output therefrom. The computational device also compares the output received from the force sensor with normative forces wherein counter-forces can be determined in response to the comparison which could be used to prevent or diminish traumatic brain or spinal cord injuries.

### BRIEF DESCRIPTION OF THE DRAWINGS

The following detailed description is best understood with reference to the following drawing in which:

FIG. 1 is a schematic cross-sectional representation of the system of the present invention.

### DETAILED DESCRIPTION OF THE INVENTION

The subject invention has utility as a model that closely resembles human DAI in order to develop protective measures for subjects.

The system of the present invention is utilized in testing processes including automobile crash analysis and other moving vehicle or device analysis including bicycles, boats, airplanes etc. The system of the present invention also has utility in the testing process for the effects of sustained high acceleration space travel, long duration hypersonic commercial jet travel, and other movement of the human body where the possibility of sudden or sustained deformative forces which can result in brain or spinal cord injuries are at play. By obtaining this data, the forces applied to an inventive simulated head can be compared with normative values and appropriate compensatory techniques can be devised in order to prevent future injury.

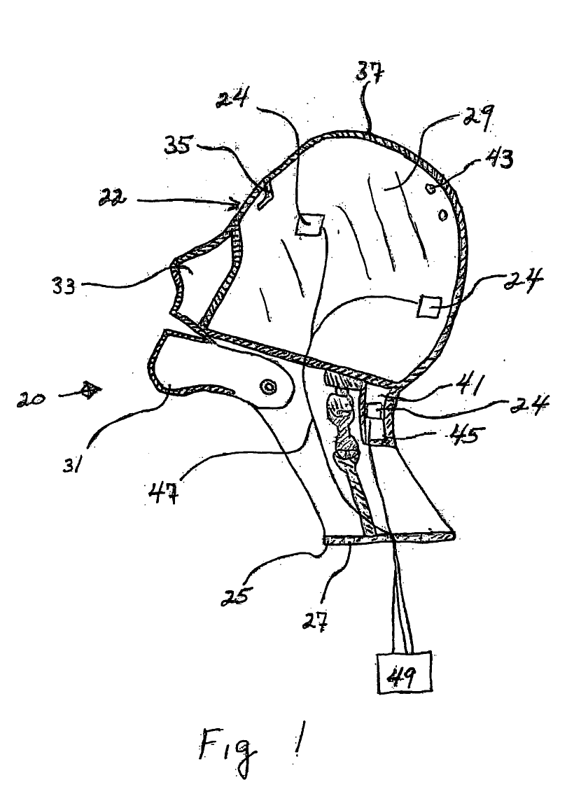

Referring to FIG. 1, a system for modeling traumatic brain and spinal cord injury is generally shown at 20.

The system 20 includes a simulated human head 22. At least one force sensor 24 is affixed thereto. The simulated human head 22 has a base plate 25 including fastener holes 27 for the optional securement of the simulated human head 22 to a mounting frame. The simulated head 22 includes anatomical details necessary for simulating trauma. The essential feature of which is a simulated brain mass 29 of a viscosity and density simulative of living brain tissue. Preferably, an access portal (not shown) is provided to service a sensor 24 or load a cast brain simulative mass 29 or spinal cord simulative mass 45. Optional anatomical features to the simulated head 22 that are useful in modeling secondary traumas associated with anatomical response to mechanical insult. Such simulative anatomical additions include a hinged jaw 31. A hinged jaw 31 is especially helpful in modeling the transmission of force delivered through the mandible or facial region. Additionally, an air cavity simulative of a sinus cavity 33 simulates a compressive space in the facial region. A baffle 35 is simulative of ocular orbits and therefore operative in simulating frontal lobe movement in response to trauma. The brain mass 29 is encompassed within a polymeric shell having the approximate shape and volume of a human head. It is appreciated that the shape and volume are varied in order to more accurately model forces experienced in infant, child, adolescent and adult heads under similar trauma conditions and therefore design appropriate safety equipment. The shell 37 is illustratively formed from metal, polymeric material such as polystyrene, polyalkylene, polycarbonate, polyacrylate, epoxy resin, copolymer such as ABS and combinations thereof. Optionally, the shell 37 is formed of an optically transparent polymer in order to facilitate high speed image collection of brain topography throughout the force transmission cycle. In the event of modeling blunt force or targeted force cerebral trauma, it is appreciated that the localized thickness and mechanical properties approximate those of skull bone tissue. A mechanical joint simulative of neck movement is well known to the art and includes a ball joint assembly 39. A still further optional inclusion in an inventive simulated head 22 is a gel-filled cavity 41 simulative of brain stem or upper spinal cord anatomy.

The material simulating brain mass 29 and/or the spinal cord 45 is a material having viscosity and a density of a living tissue intended to be simulated. According to the present invention, visco-elastic properties are measured as a Brookfield viscosity collected at physiological temperature. Materials operative to simulate brain mass or spinal cord tissue illustratively include 10-25 weight percent gelatin, silicone gel, polyacrylic acid, polyvinylpyrrolidone, polymeric beads, grain, cellulosic particulate, hollow sphere inorganic particulate, aerogel and combinations thereof. In instances where the shell 37 is transparent, the brain mass 29 or spinal cord mass 45 optionally includes a discernable visual marker, the movement of which during a trauma event can be used to calculate acceleration and deceleration forces within the simulative brain and/or spinal cord tissue masses. In the instance when a marker 43 is present, it is preferred that a grid of such markers is provided to facilitate calculation of vectoral forces during a trauma event. While a marker 43 is detailed herein with respect to a transparent shell 37 and visual recordation of brain mass movement relative to the shell, it is appreciated that magnetic detection of a magnetically active marker is also operative herein.

The force sensor 24 is preferably an accelerometer or decelerometer which is capable of converting motion or force applied thereto into an electrical output. More preferably, the force sensor 24 or a plurality thereof are employed in combination to yield force measurements in three dimensions at a proximate position. Still more preferably, a force sensor 24 is of a mass and density that limits the perturbation to the brain mass 29 created by the inclusion of a sensor 24 therein. The force sensor 24 is disposed in a particular region or sub-region of the simulated head 22 in order to ascertain readings or measurements of forces applied to the particular regions of the brain or spinal cord and is operative alone or in combination with an inventive marker 43.

A force sensor 24 includes an output wire 47 for transmitting electrical output therefrom to a computational processing unit (CPU) 49 by way of an aperture 51 in the shell 37. The CPU 49 receives and processes the information generated by the force sensor 24. In an alternate embodiment a wireless sensor 24 communicates a radio frequency signal to a CPU coupled receiver external to the lead 22. The CPU 49 preferably includes software that provides a mathematical model of anoxic-type diffuse axonal injury (DAI). The CPU 49 is preferably disposed within the simulated human head 22.

The present invention allows closed-loop analysis by constantly measuring the actual forces induced on the simulated head 22 and constantly comparing the actual forces to normative forces. Additionally, deformative forces can be constantly measured and compared against the normative forces. The values generated by the present invention are readily translated into tolerable counter-forces through the inclusion of headgear, environmental restraints and the like to cushion or otherwise lessen the damage causing capacity of the forces applied to the simulated head 22 with the understanding that the values and therefore the counter-forces are indicative of those encountered by a human in such circumstances.

In view of the teaching presented herein, other modifications and variations of the present invention will readily be apparent to those of skill in the art. The discussion and description are illustrative of some embodiments of the present invention, but are not meant to be limitations on the practice thereof. It is the following claims, including all equivalents, which define the scope of the invention.

Any patents, applications or publications mentioned in the specification are indicative of the levels of those skilled in the art to which the invention pertains. These patents, applications and publications are herein incorporated by reference to the same extent as if each individual publication was specifically and individually indicated to be incorporated by reference.

1. A system for simulating cerebrospinal injury, said system comprising:
a simulated human head having a shell defining a first volume and a base;
a brain or spinal cord simulative mass material disposed in the first volume; and
a force sensor within the volume at a preselected location.

2. The system of claim 1, wherein said shell approximates human skull mechanical properties.

3. The system of claim 1, wherein said shell has an access portal.

4. The system of claim 1, wherein said shell is optically transparent.

5. The system of claim 4, further comprising a visual marker located within the volume.

6. The system of claim 1, further comprising a magnetically detectable marker located within the first volume.

7. The system of claim 1, wherein the first volume is simulative of an anatomical feature selected from the group consisting of: a human cranial cavity and a cervical spinal cord region.

8. The system of claim 7 further comprising a second volume simulative of either a cranium or cervical spinal cord region wherein the first volume and the second volume are not simulative of the same region.

9. The system of claim 1 further comprising at least one anatomical approximating feature selected from the group consisting of: a hinged jaw, a sinus cavity and an ocular baffle.

10. The system of claim 1 further comprising a ball joint assembly simulative of human neck movement intermediate between said shell and said base.

11. The system of claim 1 wherein said brain or spinal cord simulative mass material has a density within 30% of a corresponding living tissue.

12. The system of claim 11 wherein said brain or spinal cord simulative mass material has a viscosity within 50% of the viscosity of the corresponding living tissue.

13. The system of claim 11 wherein said brain or spinal cord simulative mass material is selected from the group consisting of: 10 to 25 weight percent gelatin, silicone, polyacrylic acid, polyacrylate, polyvinylpyrrolidone, polymeric beads, grain, cellulosic particulate, hollow sphere inorganic particulate, aerogel, and combinations thereof.

14. The system of claim 1 further comprising a computational processing unit in communication with said force sensor.

15. The system of claim 14 further comprising an output wire in electrical communication between said force sensor and said computational processing unit.

16. The system of claim 14 wherein communication between said force sensor and said computational processing unit is radiofrequency communication.

17. The system of claim 14 further comprising a second force sensor located within the first volume in communication with said computational processing unit.

18. The system according to claim 14 wherein said computational processing unit further comprises software simulating axonic cerebrospinal injury.

19. A system according to claim 1 wherein said force sensor is an accelerometer.

20. A system for simulating cerebrospinal injury, said system comprising:
a simulated human head having a shell defining a first volume and a base;
a brain or spinal cord simulative mass material disposed in the first volume;
a force sensor within the volume at a preselected location;
a computational processing unit in communication with said force sensor; and
an output wire in electrical communication between said force sensor and said computational processing unit.

21. The system of claim 20, wherein the first volume is simulative of an anatomical feature selected from the group consisting of: a human cranial cavity and a cervical spinal cord region.

22. The system of claim 21 further comprising a second volume simulative of either a cranium or cervical spinal cord region wherein the first volume and the second volume are not simulative of the same region.

23. The system of claim 20 wherein said brain or spinal cord simulative mass material has a density within 30% of a corresponding living tissue.

24. The system of claim 23 wherein said brain or spinal cord simulative mass material has a viscosity within 50% of the viscosity of the corresponding living tissue.

25. The system of claim 23 wherein said brain or spinal cord simulative mass material is selected from the group consisting of: 10 to 25 weight percent gelatin, silicone, polyacrylic acid, polyacrylate, polyvinylpyrrolidone, polymeric beads, grain, cellulosic particulate, hollow sphere inorganic particulate, aerogel, and combinations thereof.

26. The system of claim 20 further comprising a second force sensor located within the first volume in communication with said computational processing unit.

27. The system according to claim 20 wherein said computational processing unit further comprises software simulating axonic cerebrospinal injury.

28. A system according to claim 20 wherein said force sensor is an accelerometer.

29. A process for simulating cerebrospinal injury comprising the steps of:
forming a simulative human head having a shell defining a first volume;
filling the first volume with a brain or spinal cord simulative mass material;
locating a first sensor within the first volume;
subjecting said simulative human head to an external force;
measuring the forces within the first volume experienced by said force sensor;
communicating said forces experienced to a computational processing unit; and
calculating an axonic injury an actual human head would experience under said external force.

30. The process of claim 29 wherein said shell is optically transparent and said brain or spinal cord simulative mass material comprises a visual marker and a time resolved image sequence of said simulative human head is collected during subjection to said external force.

31. The process of claim 29 further comprising the step of locating a second force sensor within the first volume in communication with said computational processing unit.

32. The process of claim 29 wherein communication of said forces experienced is by way of an output wire.

33. The process of claim 29 wherein communication of said forces experienced is by radiofrequency communication.

34. The process of claim 29 further comprising the step of sensing said external force.

35. The process of claim 34 further comprising the step of comparing the sensed external force with normative forces.

36. The process of claim 35 further comprising the step of predicting countermeasures to lessen said axonic injury under said sensed external force.
